(19) United States
(12) Patent Application Publication
(10) Pub. No.: US 2023/0048549 A1
(43) Pub. Date: Feb. 16, 2023

(54) COATED SEEDS

(71) Applicant: SYNGENTA CROP PROTECITON AG, Basel (CH)

(72) Inventors: Jeroen Nicolaas Antonius HOFFER, Enkhuizen (NL); Eric Markus PERSSON, Ontario (CA); Ted LABUN, Alberta (CA); Matthew Douglas John BAUMANN, Ontario (CA); Alexander Mark HEMING, Basel (CH)

(73) Assignee: SYNGENTA CROP PROTECITON AG, Basel (CH)

(21) Appl. No.: 17/797,291

(22) PCT Filed: Jan. 27, 2021
(86) PCT No.: PCT/EP2021/051803

§ 371 Date: Aug. 3, 2022

(30) Foreign Application Priority Data
Feb. 3, 2020 (EP) 20155137.1

(51) Int. Cl. A01N 25/10; A01N 25/34

(52) U.S. Cl. CPC A01N 25/10; A01N 25/34

(57) ABSTRACT

The present invention relates to a seed coating composition comprising at least: (a) a polyvinyl acetate binder, (b) activated carbon powder, and (c) at least two minerals from the group of calcium carbonate, micro-mica, vermiculite or a silicon-comprising clay. The present invention is furthermore related to the method for producing seed pellets, comprising blending the components (a) to (c), water and seeds to be coated in a pelletizer such that the seeds are coated, and, and drying the coated seeds to obtain seed pellets, and, optionally, sieving the thus obtained seed pellets.

### FIELD OF THE INVENTION

The present invention relates to a seed coating composition comprising a silicon-based mineral. The present invention furthermore relates to seeds coated with the seed coating composition. The present invention also relates to the use of the coated seeds to grow crops.

### BACKGROUND OF THE INVENTION

It is well known that the achievement of a high percentage rate of germination capacity, high speed of germination of seeds, and development of a healthy, strong bud are dependent on, inter alia, environmental conditions, such as chemical composition, biological, microbiological and physicochemical properties of the surrounding soil, as well as humidity and temperatures. Of those, the temperature and humidity of the environment of a seed are among the factors known to significantly influence the course of germination. Successful germination depends heavily on the sufficient supply of oxygen to the seed, and on the other hand, on the rapid elimination of the gaseous products of metabolism or chemical or biological reactions of bacterial origin. This is in particular relevant for pelletized seeds, since the composition and layering of the seed coating strongly influences the germination of the seed.

The advantage of seeds coated with the seed coating composition over uncoated seed is that they are composed of particles of approximately the same shape and size and have a relatively uniform density. These properties are very advantageous for example for mechanical sowing: it makes possible and/or simplifies the utilization of precision seeding; the amount of seed required can be optimized and, as a rule, be reduced; and at the same time, the yield per cropping area can be maximized.

The moisture content of seeds coated with a seed coating composition can be controlled by selecting a suitable coating material. This serves, firstly, to protect the seed from spoilage; secondly, it allows prevention of the drying-out of the seed and thus retention of its germination ability. Controlling the moisture content is in addition and of particular importance during sowing under especially dry conditions because the water present in the coating can be released.

EP-A-0013769 describes a process of granulating seed, for example of maize or sugarbeet, using vermiculite as the carrier material. This carrier material is highly gas- and liquid-permeable, and it is said that this creates equally good growth conditions for the seed under different biological conditions.

It is interesting to note that commercial pellet recipes in field crops (sugar beet, winter oil seed rape (WOSR), sunflower) are typically woodmeal-based. A reason for this may be the superior handling characteristics of woodmeal and the ease of application.

However, there is still room for improvement of the germination performance in drought stress conditions by using mineral pellets for certain kind of seeds.

### SUMMARY OF THE INVENTION

It is therefore an object of the present invention to provide a seed coating composition permitting an enhanced germination efficacy. It is a further object of the present invention to provide a composition for enhanced germination of seeds, in particular under relatively wet and dry conditions.

These and other objects are addressed by the composition of the present invention. Accordingly, the present invention relates to seed coating composition comprising at least:
(a) a polyvinyl acetate binder,
(b) activated carbon powder, and
(c) at least two minerals from the group of calcium carbonate, micro-mica, vermiculite or a silicon-comprising clay.

In a further aspect, the present invention relates to seeds coated with the compositions according to the invention. In yet a further aspect, the composition is used for growing crops with an enhanced germination and growth.

### SHORT DESCRIPTION OF THE FIGURES

The present invention now is described more fully hereinafter with reference to the accompanying drawings, in which a preferred embodiment of the invention is shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

FIG. 1 represents photos of the reference naked seeds of WOSR variety LINUS and 16 pellets made onto that same variety. The composition of each pellet can be found in table 1. The same pellet samples were made on variety SAVEO as well. Scalebars are 2 mm.

FIG. 2 represents the paper germination parameters at 10° C. of 16 pellet types and naked seed of WOSR varieties LINUS and SAVEO in two moisture conditions.

FIG. 3 represents the sand germination parameters at 10° C. of 16 pellet types and naked seed of WOSR varieties LINUS and SAVEO in two moisture conditions.

FIG. 4 represents the ordered rank sums of biological performance of pellet types on WOSR varieties LINUS and SAVEO.

### DETAILED DESCRIPTION OF THE INVENTION

Unless otherwise defined, all technical and scientific terms used herein have the same meaning as commonly understood by one of ordinary skill in the art to which this invention belongs. The terminology used in the description of the invention herein is for the purpose of describing particular embodiments only and is not intended to be limiting of the invention.

The term “polyvinyl acetate binder” as used herein, includes an aliphatic rubbery synthetic polymer with the formula (C₄H₆O₂)ₙ. It belongs to the polyvinyl ester family, with the general formula —[RCOOCHCH₂]—. It is a type of thermoplastic. Polyvinyl acetate binders are available as aqueous dispersions or as dry powders that may be mixed with water to form a dispersion or mixed with other powders before being wetted and binding those powders in a subsequent process. A person skilled in the art will be able to determine a suitable polyvinyl acetate binder and the most appropriate way to include it into a seed coating process.

The term “activated carbon powder” as used herein, includes a form of carbon processed to have small, low-volume pores that increase the surface area available for adsorption or chemical reactions. Normally, activated carbons are made in particulate form as powders or fine granules less than 1.0 mm in size with an average diameter between 0.15 and 0.25 mm. Thus they present a large surface to volume ratio with a small diffusion distance. A gram of activated carbon can have a specific surface area in excess of 500 m² per g (5,400 sq ft), with 3,000 m² (32,000 sq ft) being readily achievable. Activated carbon is usually derived from charcoal. Activated carbon can be used in methane and hydrogen storage, air purification, solvent recovery, decaffeination, gold purification, metal extraction, water purification, medicine, sewage treatment, air filters in gas masks and respirators, filters in compressed air, teeth whitening, production of hydrogen chloride in dark and many other applications. Activated carbon is carbon produced from carbonaceous source materials such as bamboo, coconut husk, willow peat, wood, coir, lignite, coal, and petroleum pitch. It can be produced by one of the following processes: (1) Physical activation: The source material is developed into activated carbons using hot gases. Air is then introduced to burn out the gasses, creating a graded, screened and de-dusted form of activated carbon. This is generally done by using one or a combination of the following processes: Carbonization: Material with carbon content is pyrolyzed at temperatures in the range 600-900° C., usually in inert atmosphere with gases like argon or nitrogen. Activation/Oxidation: Raw material or carbonized material is exposed to oxidizing atmospheres (oxygen or steam) at temperatures above 250° C., usually in the temperature range of 600-1200° C. (2) Chemical activation: The carbon material is impregnated with certain chemicals. The chemical is typically an acid, strong base or a salt (phosphoric acid 25%, potassium hydroxide 5%, sodium hydroxide 5%, calcium chloride 25%, and zinc chloride 25%). The carbon is then subjected at lower temperatures (250-600° C.). It is believed that the temperature activates the carbon at this stage by forcing the material to open up and have more surface areas or microscopic pores. Chemical activation is preferred over physical activation owing to the lower temperatures, better quality consistency and shorter time needed for activating material.

The term “micro-mica” as used herein, includes powdered mica, and mica is of the group of sheet silicate (phyllosilicate) minerals that includes several closely related materials having nearly perfect basal cleavage. All are monoclinic, with a tendency towards pseudohexagonal crystals, and are similar in chemical composition. The nearly perfect cleavage, which is the most prominent characteristic of mica, is explained by the hexagonal sheet-like arrangement of its atoms.

The term “vermiculite” as used herein, includes a hydrous phyllosilicate mineral. Vermiculite is a 2:1 clay, meaning it has two tetrahedral sheets for every one octahedral sheet. It is a limited-expansion clay with a medium shrink-swell capacity. Vermiculite clays are weathered micas in which the potassium ions between the molecular sheets are replaced by magnesium and iron ions.

The term “talc” as used herein, includes a clay mineral composed of hydrated magnesium silicate with the chemical formula Mg₃Si₄O₁₀(OH)₂. This mineral is generally used as a thickening agent and lubricant, is an ingredient in ceramics, paint and roofing material, and is also one of the main ingredients in many cosmetic products. It occurs as foliated to fibrous masses, and in an exceptionally rare crystal form. It has a perfect basal cleavage, uneven flat fracture and it is foliated with a two dimensional platy form. Talc is a trioctahedral layered mineral; its structure is similar to pyrophyllite, but with magnesium in the octahedral sites of the composite layers.

The term “silicon-comprising clay” as used herein, include silica clay complexes as for example described in EP-B-0145061. Kaolinite, illite, and chlorite are examples of silicon-comprising clays, as is talc.

The term “woodmeal” as used herein, includes wood-based powder materials with a maximum fiber thickness of 125 microns.

It is an aim of the present invention to provide a seed coating composition comprising at least: (a) a polyvinyl acetate binder; (b) activated carbon powder, and; (c) at least two minerals from the group of calcium carbonate, micro-mica, vermiculite or a silicon-comprising clay. Preferably, the coating composition comprises at least two silicon comprising minerals from the group of micro-mica, vermiculite or a silicon-comprising clay. Calcium carbonate is a filler without apparent benefits in solitary application onto seeds (WOSR), although it might raise the pH of the soil. The addition of silicon comprising minerals adds more effect to the germination of the seeds.

In contrast to silica, wood based materials are not required, and are preferably not present in the coating composition, more particularly the coating composition does not comprise woodmeal.

Advantageously, the amount of activated carbon powder is in the range of from 1 up to 10 wt %, more preferably of from 1 up to 5 wt %. Activated powder in this amount enhances the amount of liquid that is being taken. Due to the very large specific surface area and open micro-structure of activated carbon both the water holding capacity and the water permeability (conductivity) are very good. Moreover, the active chemical groups can effectively bind germination inhibiting hormones and germination inhibiting compounds in the soil environment.

Advantageously, the coating composition comprises polyvinyl acetate binder in an amount in the range of from 1 up to 10 wt %, more preferably of from 2 up to 8 wt %, even more preferably of from 2 up to 5 wt %. The PVA binder is available as a solid powder, so that it can be directly mixed in with the other powders. The benefit is for processing, and also experimentally as the amount of binder can be kept constant between pellet types, something not possible when binders are dissolved.

Advantageously, the coating composition comprises the mineral comprising silicon in an amount in the range of from 30 up to 95 wt %, preferably of from 40 up to 90 wt %. Due to the flat particle shape the mica helps to create a smooth and even coating surface (particle distribution) on seeds.

Advantageously, the composition according to the invention has a calculated density of less than 1.5 kg/I, preferably a calculated density of less than 1.3 kg/I, as this results in a favorable balance seed size increase and weight increase (buildup %).

Preferably, the composition according to the invention comprises an amount of clay less than 35 wt %, preferably less than 30 wt % of the total amount of composition. The advantage is that this is favorable to balance seed size increase and weight increase (buildup %).

In a further aspect, the present invention relates to seeds coated with the above described compositions. Advantageously, the seed is botanically classified as Brassica napus, Brassica rapa, or Brassica juncea.

Preferably, the seeds comprising the coating of this invention have the total diameter in the range of from 1.0 up to 5.0 mm, more preferably in the range of from 1.0 up to 4.0 mm. Larger seeds/pellets are more easily and accurately processed and directly benefit the field planting precision—independent of the equipment used.

Preferably, the coated seed has an essentially spherical shape.

The present invention is furthermore directed to the use of the coated seeds, for growing crops.

The present invention is also directed to the method for producing the seed coating composition, comprising blending polyvinyl acetate binder, activated carbon powder, and at least two minerals from the group of calcium carbonate, micro-mica, vermiculite or a silicon-comprising clay as described above, and optionally further comprising drying the blend.

The present invention is furthermore directed to the method for producing seed pellets, comprising blending the components polyvinyl acetate binder, activated carbon powder, and at least two minerals from the group of calcium carbonate, micro-mica, vermiculite or a silicon-comprising clay as described above, water and the seeds to be coated in a pelletizer such that the seeds are coated and drying the coated seeds to obtain seed pellets, and, optionally, sieving the thus obtained seed pellets.

Producing seed pellets is typically done by coating seeds with a mixture of activated carbon and various filler materials and bound with a polyvinyl acetate binder. The coating materials are preferably first blended as dry powders in a biaxial mixing unit until homogenized. Then seeds are typically charged to a roto-stat seed treatment unit equipped with a twin-screw powder feeder and a peristaltic pump for water addition to a spinning disc. Powder and water application rates are controlled to enable initial wetting of the seeds, then preferably at an increasing rate wetted powder is added over a certain time period. The seed pellets are then preferably transferred to a fluid bed drier and dried at a certain inlet temperature until a certain water content of is reached.

The present invention is also directed to a method to grow a plant from a coated seed, comprising sowing a seed pellet as described above into soil or a plant growth medium, and allowing the plant to grow. Compared to non-coated seeds the water relations in the soil are improved so that seeds are able to uptake available water more efficiently from the surroundings while also creating a water buffer in quickly draining sandy soils, benefitting prolonged germinations response and seedlings establishment.

The present invention is furthermore directed to improve seed germination, comprising contacting a seed with a composition comprising polyvinyl acetate binder, activated carbon powder, and at least two minerals from the group of calcium carbonate, micro-mica, vermiculite or a silicon-comprising clay as described above to form a seed pellet.

The present invention is correspondingly directed to a method of planting with a vacuum planter using the seeds coated with a composition comprising polyvinyl acetate binder, activated carbon powder, and at least two minerals from the group of calcium carbonate, micro-mica, vermiculite or a silicon-comprising clay as described above to form a seed pellet. Alternatively, an air seeder can be used for planting the seeds.

In an embodiment, treatment of Seed-borne Blackleg, Seed-borne Alternaria, Pythium spp. Fusarium spp., Rhizoctonia spp. is enhanced by the addition of pesticidally active compounds to the composition of the present invention.

Advantageously, the seed coating composition furthermore comprises a pesticidally active ingredient, more preferably one or more compounds of the group of thiamethoxam, difenoconazole, metalaxyl, metalaxyl-M and S-isomer, sedaxane, fludioxonil, sufloxaflor, cyantraniliprole, pydiflumetofen, clothianidin, penflufen, trifloxystrobin, fluopyram, mefentrifluconazole, isocycloseram, broflanilide and/or oxathiapiprolin.

Pesticidally active compounds ingredients are typically available as water-based dispersions or wettable granule or powder formulations. They may be included in the seed coating composition of the present invention (i) by addition to the seed before addition of the non-pesticidally active parts of the composition or (ii) homogenously or inhomogeneously mixed with the composition either before or during the seed coating process or (iii) by addition after the non-pestidically active parts of the composition, either before or after drying. The formulation compositions of pesticidally active compounds may contain suitable formulation adjuvants to provide shelf-life and good usability to the formulation.

Suitable formulation adjuvants are, for example, solid carriers, solvents, stabilisers, slow-release adjuvants, dyes and optionally surface-active substances (surfactants). Suitable carriers and adjuvants in this case include all substances customarily used in crop protection products. Suitable adjuvants, such as solvents, solid carriers, surface-active compounds, non-ionic surfactants, cationic surfactants, anionic surfactants and further adjuvants in the formulation compositions used in accordance with the invention are, for example, the same as those described in EP-A-0736252.

Compositions of the present invention may contain from about 0.0001% to about 5% by weight active ingredients. Suitably, the composition contains from about 0.0001% to about 2% by weight active ingredients. More suitably, the composition contains from about 0.0005% to about 1% by weight active ingredients. More suitably, the composition contains from about 0.001% to about 0.2% by weight active ingredients.

The rate of application of the pesticidal active ingredients of the present invention may vary within wide limits and depends upon the nature of the soil, the method of application, the target insect pest to be controlled, the prevailing climatic conditions, and other factors governed by the method of application and the time of application. The pesticidal active ingredients of the present invention are generally applied at a rate of 0.001 to 500 g/ha, especially from 0.001 to 100 g/ha, in particular of 0.01 to 50 g/ha. Suitably, the pesticidal active ingredients are applied at a rate from about 0.1 to about 20 g ai/ha.

Coating active ingredients onto a seed is an imperfect process. The amount of active ingredient contained on an individual seed varies according to the treatment process and type. The present invention provides for loading onto an individual seed an amount from 0.0001 to 1000 μg/seed, more particularly from 0.001 to 500 μg/seed, 0.005 to 200 μg/seed, or 0.01 to 100 μg/seed. Preferably, loading onto an individual seed ranges from 0.05 to 50 μg/seed; more preferably, from 0.1 to 20 μg/seed of active ingredient.

When the active ingredient coating process of the present invention comprises treatment with the pesticidally active formulations either before or after addition of the pelletization powders then suitably this can be a slurry treatment using a spin disc applicator (e.g., Hege treater), batch or continuous flow treaters, fluidized bed applicators, rotostatic applicators, film coaters, pan coaters, bag treaters, and any other seed treatment process known in the art. Accordingly, by a process of the present invention, it is possible to achieve a specific loading rate on a per seed basis. More particularly, a loading rate of active ingredient as defined above may be loaded onto each individual seed.

The compositions and methods of the present invention may be useful on primed and unprimed seeds. Priming is a water-based process known in the art that is performed on seeds to increase uniformity of germination and emergence from a growing medium or soil, thus enhancing plant stand establishment. Priming is also called in the art activation.

Pesticidal active ingredient formulations may be applied in mixtures with binder materials in order to bind the particles of chemical into a film and prevent dust formation by attrition of the seed during processing, transport or planting.

Examples of suitable agrochemicals include the following: Insecticides such as benzoylureas, carbamates, chloronicotinyls, diacylhydrazines, diamides, fiproles, isooxazoline, macrolides, neonicotinoids, nitroimines, nitromethylenes, organochlorines, organophosphates, organosilicons, organotins, phenylpyrazoles, phosphoric esters, pyrethroids, spinosyns, tetramic acid derivatives and tetronic acid derivatives.

Specific examples of preferred insecticides include thiamethoxam, clothianidin, imidacloprid, acetamiprid, broflanilide, oxathiapiprolin, dinotefuran, nitenpyram, thiacloprid, thiodicarb, aldicarb, carbofuran, furadan, fenoxycarb, carbaryl, sevin, ethienocarb, fenobucarb, chlorantraniliprole, cyantraniliprole, flubendiamide, isocycloseram, spinosad, spinetoram, lambda-cyhalothrin, gamma-cyhalothrin, tefluthrin, fipronil, and sulfoxaflor.

Fungicides such as acycloamino acid fungicides, aliphatic nitrogen fungicides, amide fungicides, anilide fungicides, antibiotic fungicides, aromatic fungicides, arsenical fungicides, aryl phenyl ketone fungicides, benzamide fungicides, benzanilide fungicides, benzimidazole fungicides, benzothiazole fungicides, botanical fungicides, bridged diphenyl fungicides, carbamate fungicides, carbanilate fungicides, conazole fungicides, copper fungicides, dicarboximide fungicides, dinitrophenol fungicides, dithiocarbamate fungicides, dithiolane fungicides, furamide fungicides, furanilide fungicides, hydrazide fungicides, imidazole fungicides, mercury fungicides, morpholine fungicides, organophosphorous fungicides, organotin fungicides, oxathiin fungicides, oxazole fungicides, phenylsulfamide fungicides, polysulfide fungicides, pyrazole fungicides, pyridine fungicides, pyrimidine fungicides, pyrrole fungicides, quaternary ammonium fungicides, quinoline fungicides, quinone fungicides, quinoxaline fungicides, strobilurin fungicides, sulfonanilide fungicides, thiadiazole fungicides, thiazole fungicides, thiazolidine fungicides, thiocarbamate fungicides, thiophene fungicides, triazine fungicides, triazole fungicides, triazolopyrimidine fungicides, urea fungicides, valinamide fungicides, and zinc fungicides.

Specific examples of preferred fungicides include azoxystrobin, trifloxystrobin, fluoxastrobin, cyproconazole, difenoconazole, prothioconazole, tebuconazole, triticonazole, fludioxonil, thiabendazole, ipconazole, cyprodinil, myclobutanil, metalaxyl, metalaxyl-M (also known as mefenoxam), sedaxane, and penflufen.

Nematicides such as antibiotic nematicides, avermectin nematicides, botanical nematicides, carbamate nematicides, oxime carbamate nematicides, and organophosphorus nematicides.

Specific examples of preferred nematicides include abamectin, aldicarb, thiadicarb, carbofuran, carbosulfan, oxamyl, aldoxycarb, ethoprop, methomyl, benomyl, alanycarb, iprodione, phenamiphos (fenamiphos), fensulfothion, terbufos, fosthiazate, dimethoate, phosphocarb, dichlofenthion, isamidofos, fosthietan, isazofos ethoprophos, cadusafos, terbufos, chlorpyrifos, dichlofenthion, heterophos, isamidofos, mecarphon, phorate, thionazin, triazophos, diamidafos, fosthietan, phosphamidon, imicyafos, captan, thiophanate-methyl and thiabendazole.

Nematicidally active biological agents include any biological agent that has nematicidal activity and could be used with the present invention. The biological agent can be any type known in the art including bacteria and fungi. The wording “nematicidally active” refers to having an effect on, such as reduction in damage caused by, agricultural-related nematodes. Examples of nematicidally active biological agents include Bacillus firmus, B. cereus, B. subtilis, Pasteuria penetrans, P. nishizawae, P. ramosa, P. thornei, and P. usgae. A suitable Bacillus firmus strain is strain CNCM 1-1582 which is commercially available as BioNem™. A suitable Bacillus cereus strain is strain CNCM 1-1562. Of both Bacillus strains more details can be found in U.S. Pat. No. 6,406,690.

Examples of primers and safeners include benoxacor, cloquintocet-mexyl, cyometrinil, fenclorim, fluxofenim, oxabetrinil and daimuron.

The following, non-limiting examples are provided to illustrate the invention.

### EXPERIMENTAL

All trials were done with WOSR seeds of varieties LINUS and SAVEO. The European WOSR seeds both classified botanically as Brassica napus. The seeds were coated with a mixture of activated carbon and various filler materials (see Table 1) and bound with a polyvinyl acetate binder. The coating materials were blended as dry powders in a biaxial mixing unit until homogenized. 500 grams of seed was charged to a 30 cm roto-stat seed treatment unit equipped with a twin-screw powder feeder and a peristaltic pump for water addition to the spinning disc. The powder and water application rates were controlled by a Process Logic Controller to enable initial wetting of the seeds, then addition of wetted powder at an increasing rate to achieve a target of 37.5% weight of powder compared to seed over 5 minutes. The seed pellets were transferred to a fluid bed drier and dried at an inlet temperature of 32° C. until a water content of 7.5% was reached. The resulting mixtures are given in Table 1.

TABLE 1
List of materials (in g) to make 1 kg of a selected range of pellet powder mixes.

| | Can | | | | | | | | | | | | | | | |
|---|---|---|---|---|---|---|---|---|---|---|---|---|---|---|---|---|
| Material | Std | X1 | X2 | X3 | X4 | X5 | X6 | X7 | X8 | X9 | X10 | X11 | X12 | X13 | X14 | X15 |
| loess | Primer | 75 | 310 | 310 | 310 | | | | | | | | | | | |
| woodmeal | 640 | 575 | 630 | | | 470 | 470 | 470 | | | | | | | | |
| talc | 320 | 290 | | | | | | | 470 | 470 | 470 | | | | | |
| kaolin | | | | | | | | | | | | | | | 310 | 310 |
| micromica | | | | 630 | | 470 | | | 470 | | | 470 | 470 | | 630 | |
| bentonite | | | | | | | | | | | | | | 310 | | |
| calcium | | | | | | | 470 | | | 470 | | 470 | | | | |
| carbonate | | | | | | | | | | | | | | | | |
| vermicullite | | | | | 630 | | | 470 | | | 470 | | 470 | 630 | | 630 |
| activated | | 20 | 20 | 20 | 20 | 20 | 20 | 20 | 20 | 20 | 20 | 20 | 20 | 20 | 20 | 20 |
| carbon | | | | | | | | | | | | | | | | |
| binder | 40 | 40 | 40 | 40 | 40 | 40 | 40 | 40 | 40 | 40 | 40 | 40 | 40 | 40 | 40 | 40 |

CAN STD is the Canola Standard pellet and X1 through X15 are experimental pellet recipes. Loess, kaolin, bentonite and zeolite are clays. Woodmeal with fiber thickness below 125 micron was used, talc is magnesium silicate. Micro-mica are finely milled mica platelets. Vermiculite was milled to have a median particle size of 50 micron. For each powder mix, the density is calculated based on information of the individual compounds.

### Paper Tests

Germination performance was tested on top of blotter with a white and blue standard Whatman paper in 8×8 cm plastic trays at 10° C. in a climate cabinet with a 16:8 L:D regime. Seed samples were tested in duplo with 100 seeds per replicate. The average water holding capacity of a white and a blue germination paper is 8.54 mL, i.e. no more water drips out of previously fully saturated paper. Hence, percentages of water holding capacity could be calculated and experimentally tested. Water availability stress for naked seeds became visible at 50% of the water holding capacity, and significant reductions in maximum germination and speed of germination was noted at 25% of the water holding capacity. At 25% water holding capacity, based on maximum germination, the seed-experienced water potential (ψ) approached−20 bar (permanent wilting point). Note the 25% water holding capacity was chosen for the trials but a dry 41% (3.5 mL per rep) to ensure germination would still be meaningful, i.e. performance would translate into effective plant stand for a farmer. The wet condition was set at 100% water holding capacity (8.5 mL).

### Sand Tests

A typical moisture retention curve for sand was the basis for testing a range of moisture contents for sand germination performance. The tests in sand set up by placing 4 cm of sand in a tray, sowing 100 seeds per replicate on top and a cover layer of 2 cm with the moisture content of the sand previously manipulated to be 3% and 20% by sand weight, for dry and wet conditions, respectively. Two replicates were executed.

### Analyses

Statistical analyses were performed in JMP 14.0.0. Given the amount of data on the various response variables for maximum germination and explanatory variables (moisture availability, test method, variety and pellet type) rankings were performed for the pellets for each combination of explanatory variables. As such, one set of rankings was obtained for maximum germination for all pellet types (including controls) in the paper test with dry conditions for variety LINUS. Another set of rankings was obtained for variety SAVEO for the same combination of conditions. And so on for all combinations. This procedure allowed to calculate an overall rank sum, i.e. add up all separate rankings for each pellet type with the lower ranks representing better performance.

### Results

### Pellet Appearance and Mechanical Quality

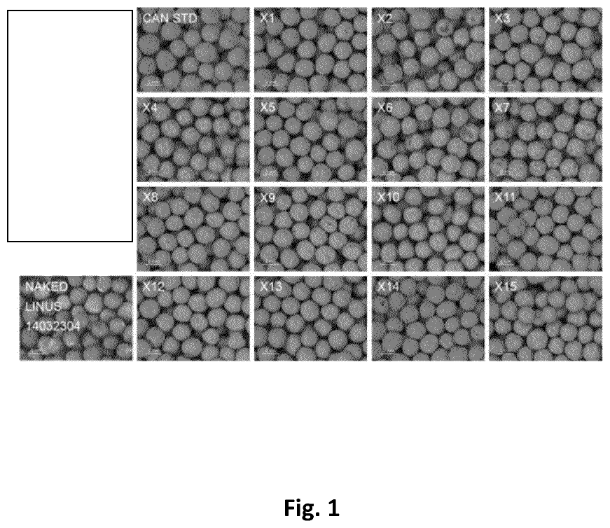

All 16 pellet mixes resulted in pellets of acceptable physical quality and appearance (FIG. 1). Pellet integrity was good for all pellets, as they were quite tough and were not easily broken during handling after drying. Evaluation of pellet appearance focused on the uniformity of coverage and the continuity of the pellet surface (FIG. 1). As the buildup was relatively small (BU 37.5%) some pellet types did not have a complete coverage, which may impact performance of the pellets. All pellets had acceptable to very good integrity, meaning that they did not break up easily and remained intact during handling. The amount of water that was used in the manufacture ranged from 36.6% to 132% water to solids, for X15 and X2 respectively.

Biological Performance

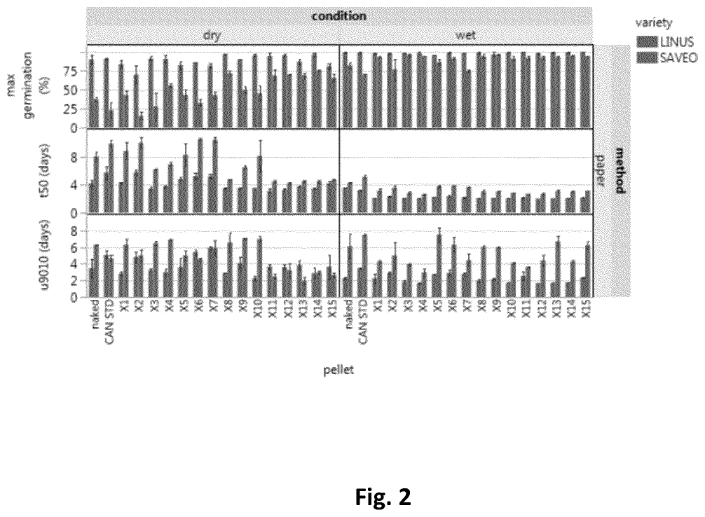

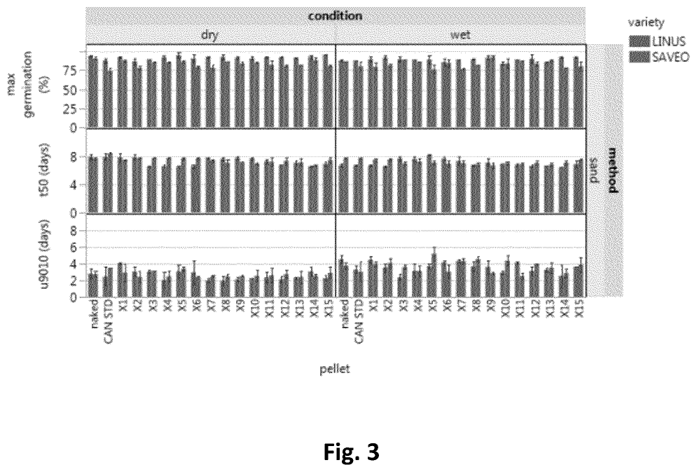

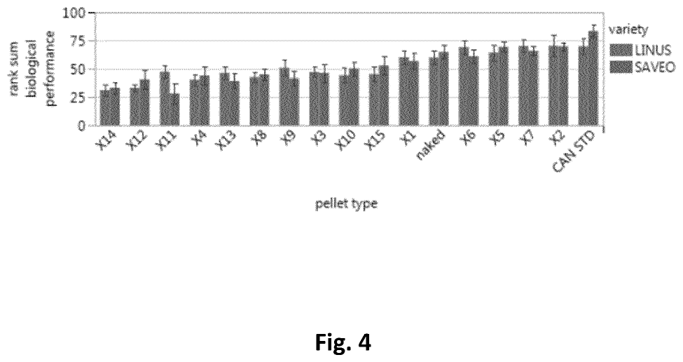

Naked seeds and 16 pellet types were tested at two moisture conditions in two different environments. Most experimental pellet types outperformed naked seed in the paper tests (see results in FIG. 4). Woodmeal pellets tended not to perform well in either moisture condition on paper. In fact, all pellets with lower performance were woodmeal-based. Differences were more pronounced in paper tests than in sand tests (compare FIGS. 2 and 3). In paper tests, the more stressful dry condition gave a better separation in performance between pellet types. Differences in pellet performance were more pronounced in the weaker SAVEO batch. In dry conditions, SAVEO pellets X8 and X11 through X14 had very good performance for maximum germination. Dry performance of LINUS on paper showed good performance for the same pellet types (FIG. 2). The linear correlation between results of the paper test and the sand test were highly significant. Many pellets outperformed the naked seeds in speed of germination (t50), the mineral pellets clearly outperformed the woodmeal-based pellets.

Pellets were ranked for maximum germination, germination speed and uniformity of germination in all combinations of conditions. Then, rank sums were calculated for each variety (see the results in FIG. 4). Specifically, for each combination of test method, moisture condition and variety a ranking was made with respect to maximum germination of the pellets incl. the untreated control. Low ranks reflect better performance. The resulting 8 rankings were then summed per pellet type incl. the untreated control to obtain the overall performance ranking.

Overall, the woodmeal pellets accumulated the higher rankings and thus demonstrated poorer overall performance. Mineral pellets X4, X8, X11 through X14 had significantly better rankings across biological parameters compared to naked seeds.

1. A seed coating composition comprising at least:
(a) a polyvinyl acetate binder,
(b) activated carbon powder, and
(c) at least two minerals from the group of calcium carbonate, micro-mica, vermiculite or a silicon-comprising clay.

2. The composition according to claim 1, wherein the composition comprises at least two silicon comprising minerals from the group of micro-mica, vermiculite or a silicon-comprising clay.

3. The composition according to claim 1, wherein the composition does not comprise wood based materials, more particularly does not comprise woodmeal.

4. The composition according to claim 1, wherein the amount of activated carbon powder is in the range of from 1 up to 10 wt %, preferably of from 1 up to 5 wt %.

5. The composition according to claim 1, wherein the amount of polyvinyl acetate binder is in the range of from 1 up to 10 wt %, preferably of from 2 up to 8 wt %, more preferably of from 2 up to 5 wt %.

6. The composition according to claim 1, wherein the amount of mineral is in the range of from 30 up to 95 wt %, preferably of from 40 up to 90 wt %.

7. The composition according to claim 1, wherein the composition has a calculated density of less than 1.5 kg/l, preferably a calculated density of less than 1.3 kg/l.

8. The composition according to claim 1, wherein the amount of clay is less than 35 wt %, preferably less than 30 wt % of the total amount of composition.

9. The composition according to claim 1, wherein the seed coating composition furthermore comprises a pesticidally active ingredient, preferably one or more compounds of the group of thiamethoxam, difenoconazole, metalaxyl, metalaxyl-M and S-isomer, sedaxane, fludioxonil, sufloxaflor, cyantraniliprole, pydiflumetofen, clothianidin, penflufen, trifloxystrobin, fluopyram, mefentrifluconazole, isocycloseram, broflanilide and/or oxathiapiprolin.

10. The composition according to claim 9 where the pesticidally active ingredient is included (i) by addition to the seed before addition of the non-pesticidally active parts of the composition or (ii) homogeously or inhomogeneously mixed with the composition either before or during the seed coating process or (iii) by addition after the non-pestidically active parts of the composition, either before or after drying.

11. A seed coated with the seed coating composition according to claim 9.

12. A seed according to claim 11, wherein the seed is botanically classified as Brassica napus, Brassica rapa, or Brassica juncea.

13. A seed according to claim 11, wherein the total diameter of the coated seed is in the range of from 1.0 up to 5.0 mm, preferably in the range of from 1.0 up to 4.0 mm.

14. A seed according to claim 11, wherein the coated seed has an essentially spherical shape.

15. Use of the coated seeds according to claim 11, for growing crops.

16. A method for producing a composition according to claim 1, comprising blending components (a) to (c).

17. A method for producing seed pellets, comprising blending the components (a) to (c) according to claim 1, water and seeds to be coated in a pelletizer such that the seeds are coated, and, and drying the coated seeds to obtain seed pellets, and, optionally, sieving the thus obtained seed pellets.

18. A method to grow a plant from a coated seed, comprising sowing a seed according to claim 12 into soil or a plant growth medium, and allowing the plant to grow.

19. A method to improve seed germination, comprising contacting a seed with a composition according to claim 1 to form a seed pellet.

20. A method of planting with a vacuum planter using the seeds of claim 10.
